(19) United States
(12) Patent Application Publication
(10) Pub. No.: US 2022/0117262 A1
(43) Pub. Date: Apr. 21, 2022

(54) Textured Plant Protein Product and Method

(71) Applicant: Glanbia Nutritionals Limited, Kilkenny (IE)

(72) Inventors: Gbenga Olatunde, Portage, MI (US); Jason Demmerly, Kimberly, ID (US)

(21) Appl. No.: 17/567,144

(22) Filed: Jan. 2, 2022

Related U.S. Application Data
(63) Continuation of application No. PCT/US20/64927, filed on Dec. 14, 2020.
(60) Provisional application No. 62/947,504, filed on Dec. 12, 2019.

(51) Int. Cl. A23J 3/22; A23J 3/14; A23J 3/34

(52) U.S. Cl. CPC A23J 3/227; A23J 3/346; A23J 3/14

(57) ABSTRACT

Disclosed is a method for producing textured plant protein products using an admixture of at least one plant protein and transglutaminase. The method provides a means for forming textured pea protein products, for example, that can be used in a variety of applications, particularly in food products comprising vegan meat substitutes.

### FIELD OF THE INVENTION

The invention relates to meatless protein products and methods for making those products. More specifically, the invention relates to methods for making textured plant protein products and products made by those methods.

### BACKGROUND OF THE INVENTION

In the United States alone, the market for plant-based meat alternatives is estimated at from $800 million to $1.4 billion. Analysts predict that the market for alternative meat could reach $140 billion within the next ten years, potentially capturing about 10% of the $1.4 trillion global meat market. Consumer acceptance of plant-based meat substitutes has increased, fueled largely by a combination of the health benefits of plant-based nutrition and the potential to decrease the environmental impacts of meat production to meet the needs of an ever-increasing human population. A multitude of new meatless protein products and brands have been developed, all with the goal of providing plant-based protein products with the taste and texture of meat.

The most common proteins utilized in meat substitutes are soy protein and wheat gluten, primarily because of the processing advantages they provide, as well as their abundance, availability and low cost. However, consumers have become more interested in soy-free and gluten-free products, so pea protein is becoming a more and more attractive option. It is the plant protein highest in the amino acid leucine and is also rich in arginine and lysine. Also, processing of pea protein requires significantly less water than does processing soy protein or meat protein, providing a more environmentally-sustainable option as a source of dietary protein.

However, textured vegetable protein, used as, or as an ingredient in, many types of meat substitutes, has traditionally been made from soy flour, soy concentrate, and/or soy isolates, and while pea protein is an attractive alternative, the use of pea protein has presented some challenges. As Shand et al. noted, pea protein products “have been reported to exhibit comparable and complementary functionality to homologous soybean protein products, however, it has been noted that heat-induced gels of pea proteins were weaker than soy protein gels.” (Shand, P. J., et al. Physicochemical and textural properties of heat-induced pea protein isolate gels, Food Chemistry 102 (2007) 1119-1130.) This is important because formulating meat substitutes generally involves producing gelatinized matrices, or gels, comprising one or more plant proteins.

Textured protein products are generally produced as fibers, shreds, chunks, bits, granules, slices or similar food forms. Textured vegetable protein “can be described as food items that wholly or partially take the place of meat in the human diet and that have an appearance, texture and nutritional content similar to meat products.” (Riaz, M. N., Texturized vegetable proteins, Handbook of Food Proteins (2011) p. 395-418, Woodhead Publishing Series in Food Science, Technology and Nutrition.) Textured vegetable protein (TVP) has been on the market for over 50 years, the widely-used term “TVP” having been trademarked by the Archer Daniels Midland company in the 1960s. However, with the increasing interest in, and demand for, meatless protein products, development of new vegetable protein products with better flavor, texture, soy-free and gluten-free, has been a goal for ingredient companies, companies that produce vegan and vegetarian foods, and even some companies that traditionally have been known solely for meat production.

Pea flour and concentrates have previously been used for texturization. However, Riaz observed that “[t]hese raw materials are somewhat variable, have often been extensively heat treated prior to extrusion, and are therefore very difficult to texturize.” (Riaz, M. N., Texturized vegetable proteins, Handbook of Food Proteins (2011) p. 402, Woodhead Publishing Series in Food Science, Technology and Nutrition). Most textured vegetable protein products are produced using heat extrusion technology. This has required high-temperature (producing significant protein denaturation) and high-pressure processing using additional ingredients such as starches to aid in development of the gelatinized matrix that is the goal of the texturization process. For example, U.S. Pat. No. 8,728,560 (Boursier et al., 20 May 2014) discloses the addition of sodium metasulfite and gypsum to reduce the formation of disulfide bridges in the protein and strengthen the textured product, respectively. However, most consumers prefer “clean-label” products that have few ingredients, and even more important to them is the idea that those ingredients be easily recognizable as safe, simple, food ingredients.

For over 50 years, the state of the art in the field of production of texturized proteins has been extrusion technology. Efforts continue to be made to improve on that technology. However, what are really needed are new and better processing methods for making textured-protein-based products that provide cost-effective options for processing ingredients for use as meat substitutes and/or meat extenders while retaining the nutritional value the protein(s) can provide.

### SUMMARY OF THE INVENTION

The invention provides a method for producing at least one textured plant protein product, the method comprising the steps of admixing water, transglutaminase, and plant protein to produce a water/transglutaminase/protein admixture; holding the admixture for a period of time sufficient to produce a gelatinized protein cake; grinding the gelatinized protein cake to produce a ground protein product; and drying the ground protein product at a drying temperature from about 60 to about 300 degrees Celsius to produce a textured pea protein product. The invention also relates to textured protein products made by the method, and to meat substitutes made using those textured protein products.

In various aspects of the invention, the plant protein is pea protein. In various aspects, the ratio of water to protein in the admixture comprises from about 0.5:1 to about 5:1, by weight. In various aspects, the transglutaminase is added at from about 0.0001 percent to about 10 percent of the admixture, by weight, and in various aspects the holding time can be a period of from about 0.5 to about 60 minutes to produce a gelatinized protein cake, with those of skill in the art recognizing that holding time can vary according to the amount or concentration of transglutaminase used. In various aspects of the invention, the grinding is performed using a meat grinder.

### BRIEF DESCRIPTION OF THE DRAWINGS

FIGS. 1 through 4 illustrate the impact of degree of wetting on the physical appearance of a textured pea protein.

FIG. 1 is a photograph of a textured pea protein product produced with a 75% degree of wetting (1:3 ratio pea protein to water), dried at 210° C.

FIG. 2 is a photograph of a textured pea protein product produced with a 60% degree of wetting (1:1.5 ratio pea protein to water), dried at 210° C.

FIG. 3 is a photograph of a textured pea protein product, made in a rectangular shape, produced with a 60% degree of wetting (1:1.5 ratio pea protein to water), dried at 210° C.

FIG. 4 is a photograph of a commercially-available textured pea made using an extrusion process.

FIG. 5 is a photo of a freshly-rolled meat ball made using the product of the invention (using pea protein).

FIG. 6 is a photo of the same type of meatball (pea protein) that has been freshly-rolled and coated using a coating comprising 1% Flax.

FIG. 7 is a photo showing a freshly-cooked vegetable protein (pea protein) meatball.

FIG. 8 is a photo of a cooked beef-based meat ball.

FIG. 9 is a photograph of a freshly-made vegan patty made using the product of the invention (using pea protein).

FIG. 10 is a photograph of a freshly-cooked vegan patty made using the product of the invention (using pea protein).

FIG. 11 is a photograph of a freshly-made and cooked sausage made using the product of the invention (using pea protein).

FIG. 12 is a photograph of a cut profile of a fresh sausage made using a product made by the method of the invention.

FIG. 13 is a photograph of a freshly-made “chicken” nugget made using a product of the invention.

FIG. 14 is a photograph of the same nugget as in FIG. 13 after being dipped in tempura and fried.

### DETAILED DESCRIPTION

The inventors have developed a method for producing textured plant protein products that does not require the customary use of the extended temperature/pressure levels required for extrusion processing, providing a more cost-effective, more clean-label, textured protein that the inventors have used to make a variety of meatless protein products such as vegan meatballs, vegan patties (e.g., burgers, sausage), vegan sausage links, vegan crumbles and vegan chicken-nugget-type products. These products exhibit a very meat-like texture and pleasant flavors by adding different types of flavors and spices to produce different categories of products.

The invention provides a method for producing a textured pea protein product, the method comprising the steps of admixing water, transglutaminase, and pea protein to produce a water/transglutaminase/pea protein admixture; holding the admixture for a period of time sufficient to produce a gelatinized protein cake; grinding the gelatinized protein cake to produce a ground protein product; and drying the ground protein product, at a drying temperature of from about 60 to about 300 degrees Celsius, to produce a textured pea protein product.

In various aspects of the invention, the ratio of water to pea protein in the admixture comprises from about 1:1 to about 3:1. In various aspects, the transglutaminase is added at a level of from about 0.001 percent to about 0.003 percent of the admixture, by weight. In various aspects, flavorings are added at from about 0.01 percent to about 20 percent of the admixture, by weight. In various aspects of the invention, the grinding step is performed by a meat grinder. The holding time for holding the admixture can be in the range of from about 0.5 to about 60 minutes, with those of skill in the art recognizing that the requisite time can vary according to the amount of transglutaminase used.

Pisum sativum (garden pea, field pea, spring pea, English pea, common pea, green pea) is a pulse species cultivated in several countries as a source of protein. Tulbek et al. describe the cultivation, nutritional value, and processing of peas (Tulbek, M. C. et al. Pea: A Sustainable Vegetable Protein Crop, Sustainable Protein Sources (2017) p. 145-164). Although it had previously been reported that transglutaminase could be used to cross-link pea protein, Tulbek et al. also disclose that “[c]urrent research indicates that pea protein products tend to exhibit weaker gel strength, viscosity, and texture compared to egg, soy, and meat proteins.” However, the inventors have successfully utilized the cross-linking effects of transglutaminase to provide a type of gel that can be reduced in size and dried to produce a textured pea protein product that can be used instead of textured soy protein, for example, to provide a soy-free, gluten-free meat substitute or ingredient for meat substitute products such as vegan sausages, burgers, “chicken” nuggets, meatballs, etc. They chose to develop a method for producing these products that would not require the use of the most common method for producing textured protein products—high temperature, high pressure extrusion.

In the method of the invention, the inventors have used the combination of enzyme cross-linking, protein hydration, flavor, grinding of the gel resulting from the hydration and cross-linking, and drying temperature to produce clean-label products having a texture and consistency that is very similar to that of meat and can readily be used as meat substitutes. Where the term “grinding” is used, however, it should be understood by those of skill in the art that the term is used herein to describe grinding, pulverizing, crumbling, mashing, milling, crushing, grating, and other similar methods for reducing the size of a protein cake to form smaller pieces of appropriate size for use as a texturized protein product. For example, the product may be pressed through a metal plate comprising at least one aperture of desired shape, so that product pieces are formed as the product is pressed through the plate. Such a plate can be used as a die, providing apertures of desired size and shape, to form textured plant protein products of varying sizes and shapes. These may be desirable for producing a variety of different types of products, including, for example, what are known in the art as “crumbles,” strips (such as meatless steak strips, meatless chicken strips), bacon strips, and other products.

Transglutaminase (2.3.2.13, protein-glutamine:amine γ-glutamyl-transferase) cross-links proteins by transferring the γ-carboxyamide group of the glutamine residue of one protein to the ε-amino group of the lysine residue of the same or another protein. Transglutaminase is commonly used in the food industry for a variety of applications, and it can be produced by a variety of bacteria such as, for example, Streptomyces mobaraensis, Streptomyces libani, Bacillus circulans, Bacillus subtilis, Streptomyces ladakanum. In 1989, microbial transglutaminase was isolated from Streptoverticillium sp. Transglutaminase is often provided in powder form, particularly for large-scale use in the food industry, and is available from a variety of commercial providers. Suitable transglutaminase enzymes for use in the method of the invention include, for example, those of microbial origin, which are widely available commercially.

The invention is described as a method for producing products made of pea protein. However, it should be clear to those of skill in the art that the method described herein can also be used for protein sources selected from the group consisting of pea protein concentrate, pea protein isolate, and other protein concentrates and isolates from other pulses such as red, green, yellow and brown lentils, chickpeas (chana or garbanzo beans), garden peas, black-eyed peas, runner beans, broad beans (fava beans) and kidney beans, for example. Also useful are proteins selected from the group consisting of rice protein isolate, rice protein concentrate, and soybean protein concentrate, soybean protein isolate, wheat protein concentrate, wheat protein isolate, teff protein concentrate, teff protein isolate, oat protein concentrate, oat protein isolate, corn protein concentrate, corn protein isolate, barley protein concentrate, barley protein isolate, sorghum protein concentrate, sorghum protein isolate, rye protein concentrate, rye protein isolate, millet protein concentrate, millet protein isolate, amaranth protein concentrate, amaranth protein isolate, buckwheat protein concentrate, buckwheat protein isolate, quinoa protein concentrate, quinoa protein isolate, and combinations thereof.

The method requires few steps and is very cost-effective—requiring only protein, enzyme, and optionally, flavor and spices, to prepare an exceptional textured pea protein product (TG-TPP) and an outstanding clean label option for meatless protein products. Briefly, the method can generally be performed by adding at least one pea protein to a container in which the product can be mixed/stirred. Plant proteins, such as pea protein, for example, are commercially available as protein isolates or protein concentrates, for example, in powder form (or, for example, as liquid compositions comprising protein and water). Transglutaminase enzyme is admixed with the pea protein. Optionally, flavor, spices, starches, carbohydrates, lipids, and other macro- and micronutrients can be added to enhance desired functional and/or nutritional characteristics, depending upon the end product that is desired, as the present method can be used to produce a variety of meatless protein products. Mixing (e.g., stirring) is performed for a period of time—usually less than 30 minutes. For example, ten minutes of mixing has been used by the inventors with great success. Tap water (at a temperature of about 55 degrees C.) is added to the protein/enzyme mixture with continued stirring for less than about 2 minute(s). (It should be understood by one of skill in the art that if a liquid protein composition is used as a starting material, the addition of water may either be unnecessary or the amount reduced—i.e., the liquid protein composition may provide the amount and ratio of water and protein.) By way of non-limiting example, the resulting batter can be transferred to a container to form a “cake” to which moderate compression force is applied, and the compressed cake rested at room temperature for a brief period of time (which in some cases may, for example, need be no longer than 30 minutes). The cake is then milled using, for example, a meat grinder. The ground product is dried, using convection drying, for example, to produce a textured pea protein (TG-TPP) that can be used in a variety of food applications. Several of these applications are described in the Examples herein. Suitable methods for drying the ground protein product are known to those of skill in the art, and include, for example, various forms of convection drying.

A “gelatinized protein cake,” as used herein, is a mass of protein that has been sufficiently cross-linked by the transglutaminase in the mixture to produce a relatively formed, somewhat gelatinous, loaf, block, lump, etc. that can be reduced to smaller pieces by various means such as, for example, grinding, pressing the loaf through a metal plate comprising at least one aperture of desired shape so that product pieces are formed as the product is pressed through the plate, etc.

To produce some formed meatless or vegan products, it is beneficial to combine at least one textured protein product made by the method of the invention (e.g., textured pea protein) with a mixture of pea protein and transglutaminase, a mixture of pea protein and at least one hydrocolloid, or a combination of both, for example, to serve as a binder for the textured protein. In this case, transglutaminase is used at from about 0.001% to about 10%, by weight of dry ingredients. Suitable hydrocolloid sources include, for example, plant sources such as flax, chia, and combinations thereof, and gums such as carrageenan, gum arabic, locust bean methylcellulose, guar gum, gellan gum, tara gum, konjac gum, modified gum acacia, xanthan gum, pectin, and combinations thereof. Briefly, by way of example, a product such as a vegan meatball can be formed by this method by adding textured vegetable protein (as prepared by the method described above), reconstituted by admixing it with boiling water and cooking for 10 minutes, with pea protein, one of more hydrocolloids (e.g., a gum system prepared by admixing flax and pea protein at a ratio of about 40 to about 60, by weight), oil (e.g., hydrogenated palm kernel oil), and a seasoning blend. The textured vegetable protein is added to the dry blends and thoroughly mixed together. Oil and water can be added and mixed, and the resulting batter can be molded into balls and allowed to rest on a table top for 30 minutes before cooking the resulting product. Alternate methods for reconstitution of the TG-TPP are, of course, suitable for use in this method, such as, for example, adding boiling water to the TG-TPP and allowing that mixture to sit for 15 minutes on a table top or counter to achieve reconstitution of the textured vegetable protein.

The present method, products made by the method, and meat substitutes made using those products are described herein using the term “comprising.” However, it should be understood that “comprising” encompasses within its bounds the more narrowly-interpreted terms “consisting of” and “consisting essentially of.” The present method, products made by the method, and meat substitutes made using those products can therefore also be described using those terms. The method has been described as a method for making “a” textured protein product, but it should also be understood by those of skill in the art, given the disclosure herein, that variations of the method can be used to make variations of the product(s), resulting in a variety of different products that can actually be made using the method disclosed herein. That is, at least one textured protein product can be made by the method of the invention. Products made according to the method of the invention can be further described by means of the following non-limiting examples.

### EXAMPLES

Pea protein (Glanbia Plc., USA) and Transglutaminase, TG-5802 (Taixing Dongsheng Bio-Tech Co., LTD., China) were used in making the textured pea protein (TPP). The pea protein has the following characteristics: protein content (>80% d.b), Ash (<8%) fat (<10%) and moisture (<9%).

### Optimization of Processing Conditions for the Production of TPP

A complete factorial design (3×3×3×2) was used to establish the optimization condition for textured pea protein (TPP) (Table 1). Briefly, 500 g of pea protein was weighed using a digital weighing balance with 0.1 g precision (Model ML4002E, Mettler Toledo, Switzerland) into the mixing bowl of a stand mixer (Model KSM6573C0B, KitchenAid®, USA). The desired amount of Transglutaminase was measured and added to the pea Protein® and mixed together for 10 minutes by setting the stirring rate of the KitchenAid® mixer to level 2. Tap water (55° C.) was measured and added to the mixture while stirring. The entire mixing operation, starting from the point of adding warm water to the admixture to when mixing action was stopped, was no longer than 1 minute. The batter was emptied into a bowl and moderate compressive force was applied to form a cake. The cake was allowed to stand at room temperature for the time periods shown in Table 1.

The gelled textured pea cake was removed from the container by gently tapping on the bottom and side of the container. The cake was subsequently sliced into sizes to facilitate milling in the meat grinder (Model HL200, Hobart, USA). The meat grinder comprised a holding area and the milling chamber. The milling chamber comprised mainly, the screw conveyor that is connected to electric motor, cutting blade and the die/shaper (¼″). The screw conveyor provides a clockwise movement that crushes the cake and transports it to the die which is located at the outlet of the milling chamber. As the screw conveyor pressed the batter against the surface of the die, the cutting blade slice through the batter to prevent formation of long strand TVP. The TVP was then immediately divided into two equal part and dried in an industrial convective dryer (CO41408, MIWE condo, Arnstein Germany) with a preset temperature of 60° C. and 210° C., respectively.

TABLE 1
Optimization of parameters for the production
of the textured vegetable protein

| Parameters | Levels | | |
|---|---|---|---|
| Transglutaminase, TG-S802 | 0.0005 | 0.001 | 0.003 |
| (as % inclusion rate) | | | |
| Pea protein (g) | 500 | | |
| Pea protein:Water (protein | 1:1 | 1:1.5 | 1:3 |
| to water ratio) (g) | | | |
| Milling die shape (¼″) | Rectangular, circular | | |
| Holding duration (minutes) | 30 | 20 | 10 |

In order to evaluate the TPP, 20 g dried TPP was added into 200 g boiled water in a beaker for 10 minutes holding duration. The water was removed by pouring the sample onto a screen with pore size of 600 μm. Samples were subsequently analyzed for taste, aroma, color, water absorption, texture profile analysis hardness, adhesiveness, cohesiveness, springiness, and chewiness. The dried TPP was analyzed for amino acid, protein content, carbohydrate, ash and lipid content. The optimized TPP was selected for the subsequent experiment.

In the second part of the study, six formulations for each of meat analogue nugget, meatball, sausage, meat patties and meat crumbles were developed following the template shown in Table 2. For example, The TPP was milled into two different grade (fine and coarse) particles, presoaked in boiling water for 10 minutes, and then squeezed to remove the water using a screen mesh. After mixing all the ingredients, the desired batter was molded according to the desired application (nugget, meatball, sausage, crumbles and meat patties). For crumbles, water and season blend was brought to boiling and the TPP was added. The admixture was cooked until all the water was soaked up by TPP or completely evaporated.

The 10% TG pea ingredient is an admixture of transglutaminase and pea protein at the ratio of 10 to 100, by weight. The starch and gum system is an admixture of flax and pea protein at the ratio 40 to 60, by weight. The canola/coconut oil blend is an admixture of canola oil and coconut oil at the ratio of 60 to 40, by weight.

TABLE 2
Formulation for meat analogue nugget,
meatball, sausage and patties

| | Formulation | | | | |
|---|---|---|---|---|---|
| Component/Ingredient (%) | 1 | 2 | 3 | 4 | 5 |
| Textured vegetable protein | 10 | 20 | 40 | 60 | 90 |
| Pea protein(g) | 16.2 | 14.2 | 10.2 | 6.2 | 0.2 |
| Starch/gum blend | 16.2 | 14.2 | 10.2 | 6.2 | 0.2 |
| Water | 48.6 | 42.6 | 30.6 | 18.6 | 0.6 |
| Canola/coconut oil blend | 5.4 | 5.4 | 5.4 | 5.4 | 5.4 |
| Seasoning blend | 3.6 | 3.6 | 3.6 | 3.6 | 3.6 |

### Water Absorption Index

The water absorption index testing procedure was adapted from an American Soybean Association technical bulletin (1988). This test analyzes the amount of water a TPP will absorb at a set weight of product and set time. Twenty grams of textured wheat gluten was soaked in 100 mL of room temperature water for 20 minutes. After soaking, the hydrated product was drained on a screen for 5 minutes. The final weight was recorded. To calculate the Water Absorption Index, the following equation is used:

$$Water Absorption index = \frac{Rehydrated wt . - Original Wt}{Original Wt .}$$

### Texture Profile Analysis (TPA)

The textural properties of rehydrated TPP samples were measured using a texture analyzer (TA-XT plus, Stable Micro Systems, UK). The TA-42 blade is 3 mm thick, 7 cm wide and has a 45° chisel edge typically recommended for measurement of product overall firmness. Four pieces of the TPP were arranged perpendicularly to the blade as it moved at 1 mm/sec until 5 g resistance was sensed. Then it slowed to 0.5 mm/sec and continued 90% of the way through the products. Parameters obtained from the analysis included hardness, adhesiveness, cohesiveness, springiness, gumminess and chewiness.

### Color Measurement

The dried and the rehydrated TPP were used for the evaluation of the effect of TPP on the change of color. The values of L* (lightness), a* (redness), b* (yellowness) C* (chroma) and ° h (hue angle), were measured by the CIELAB color system using a spectrophotometer (Model 45/0, ColorFlex EZ USA). Prior to the analysis, the equipment was standardized using the white calibration plate.

### Amino Add Composition

The complete amino acid profile was performed using the AOAC (1990). Amino acid composition of products made by the method of the invention were similar to those of commercially-available TPP products made using extrusion technology.

### Statistical Analysis

All experiments were performed in triplicate and data was expressed as means±SD. The significant differences among means were determined by the analysis of variance (ANOVA) using Duncan's multiple comparisons at p≤0.05.

### Sensory Evaluation

Sensory tests for TPP nugget, meatball, sausage, and patties were conducted with a total of 10 panelists. A hedonic scale of 9 points was used and the attributes were appearance, color, texture, aroma, taste, and overall acceptance. All nugget, meatball, sausage and patties were cut into rectangle shape and presented to panelists on a plate with a three-random digit coded number to avoid bias. The score was based on a 9-point hedonic scale ranging from 1 (extremely dislike) to 9 (extremely like).

### Impact of Degree of Wetting on Physical Appearance of Product

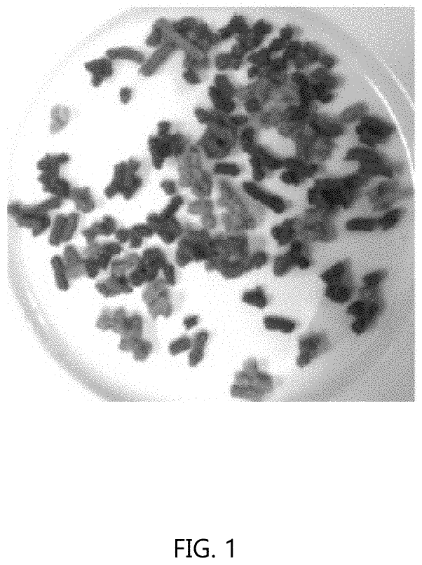

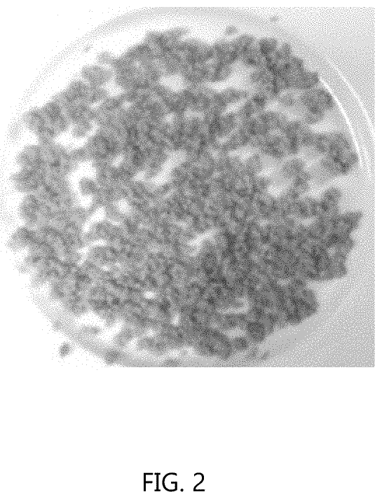

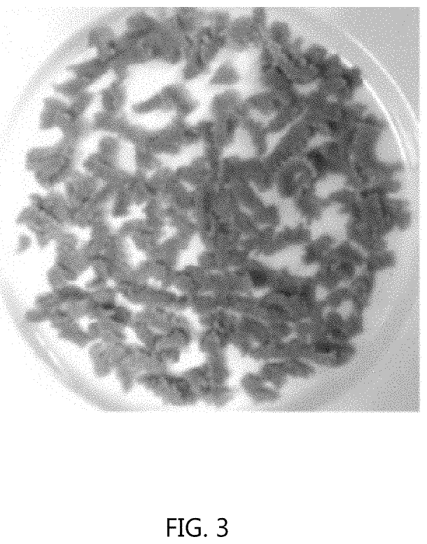

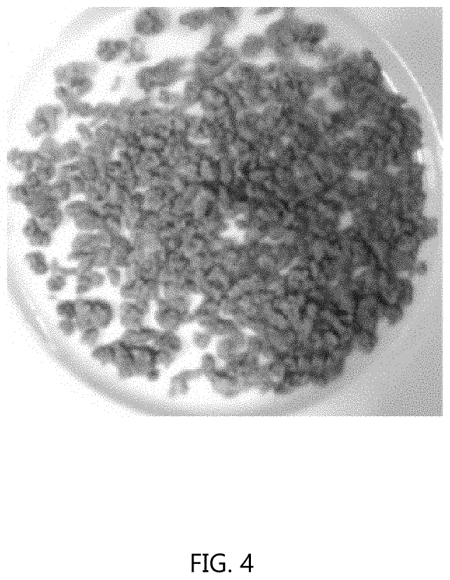

The impact of degree of wetting on the physical appearance of the textured pea protein is presented in FIGS. 1-4. The result showed when the degree of wetting increased, the surface roughness of the textured pea surfaces became smoother and degree of thermal induced browning during drying increased (FIG. 1). However, the appearances of the textured pea obtained at degree of wetting below 65% were comparable with the commercially available textured pea. Table 3 shows the analysis of the textured pea and commercially available product, respectively. The textured pea protein produced by the method of the invention has 85% protein content, while commercially available textured pea protein has a 65% protein content, on average. Amino acid analysis and comparison showed no significant difference between the present textured pea protein and commercially-available products. In addition, there was no thermal degradation as a result of drying at 210° C. in comparison with drying at 70° C. However, at high degree of wetting, low temperature drying (below 70° C.) can result in extended-duration drying and thermally-induced browning.

TABLE 3
Analytical Comparison of Textured Pea Product
and Commercially-Available Products

| | Glanbia TVP* | Nutri-Crisps ® | ProFood |
|---|---|---|---|
| Moisture Content | 3.63 | 8.15 | 8.8 |
| (%) | | | |
| Protein (Nx 6.25) | 85.6 | 66.8 | 63.3 |
| (%) | | | |
| Ash (%) | 3.27 | 2.98 | 4.54 |
| Lipid (%) | 9.51 | 7.82 | 9.24 |
| Carbohydrate (%) | 1.62 | 14.12 | 14.12 |

*Glanbia TVP is a textured pea protein product made by the method of the invention; Nutri-Crisps ® (Cereal Ingredients, Inc., Leavenworth, KS); ProFood (ProFood International, Chicago, IL).

### Impact of Degree of Wetting on Color Profile

The impact of degree of wetting on the color profile of the textured pea protein and two different commercial products is presented in Table 4. Delta E is the measure of change in visual perception of two given colors, based on the following categories: <=1.0—Not perceptible by human eyes; 1-2—Perceptible through close observation; 2-10—Perceptible at a glance; 11-49—Colors are more similar than opposite; 100—Colors are exact opposite. A contrast in color between commercial product 1 and a product of the invention using the Transglutaminase inclusion rate of 0.0010% and 0.0030% is shown in Table 4. Results indicated that the Delta E obtained demonstrated that the two products are perceptible at a glance. Similar results (Table 5) were obtained for commercial product 2. However, comparing the textured pea developed by the inventors vs each of the commercial textured pea products, as the degree of wetting increased beyond 60%, the ease of perception of differences significantly increased. Degree of wetting denoted by (1:1) means 1 gram of pea protein isolate to 1 gram of water.

TABLE 4
Delta E Results for Color Analysis of Product of the Invention
vs Commercially-Available Textured Pea Protein Product 1

| Enzyme | | | |
|---|---|---|---|
| Inclusion | Degree of Wetting (%) | | |
| Level (%) | 50 (1:1) | 60 (1:1.5) | 75 (1:3) |
| 0.0010 | 4.3 | 4.4 | 10.9 |
| 0.0030 | 4.2 | 3.5 | 6.4 |

TABLE 5
Delta E Results for Color Analysis of Product of the Invention
vs Commercially-Available Textured Pea Protein Product 2

| Enzyme | | | |
|---|---|---|---|
| Inclusion | Degree of Wetting (%) | | |
| Level (%) | 50 (1:1) | 60 (1:1.5) | 75 (1:3) |
| 0.0010 | 11.7 | 12.5 | 18.5 |
| 0.0030 | 11.5 | 11.7 | 14.5 |

### Impact of Soaking Product in Boiled Water for 10 Minutes—Degree of Hardness

The impact of processing (represented as boiling in water for 10 minutes) was assessed by measuring the degree of hardness for products produced using three different degrees of wetting (50%, 60%, and 75%) and two different levels of transglutaminase used to cross-link the protein (0.0010% vs. 0.0030%). The experiment was repeated 10 times, with the results being represented as the mean, with standard deviation ( ). Results are shown in Table 6.

TABLE 6
Comparison of Hardness Levels*

| Enzyme Inclusion | Degree of Wetting | | |
|---|---|---|---|
| Level (%) | 50% (1:1) | 60% (1:1.5) | 75% (1:3) |
| 0.0010% | 4886.6 (122.5) | 2378.6 (54.8) | 5525.2 (266.2) |
| 0.0030% | 900.2 (34.8) | 872.5 (39.2) | 820.0 (50.7) |

*Hardness levels reflect impact of processing (boiling in water for 10 minutes) on products produced using three different degrees of wetting (50%, 60%, and 75%) and two different levels of transglutaminase (0.0010% vs. 0.0030%) used to cross-link the protein.

### Impact of Soaking Product in Boiled Water for 10 Minutes—Water Absorption Index

The impact of processing (represented as boiling in water for 10 minutes) was assessed by measuring the water absorption index for products produced using three different degrees of wetting (50%, 60%, and 75%) and two different levels of transglutaminase used to cross-link the protein (0.0010% vs. 0.0030%), as well as for two separate commercially-available products. Results are shown in Table 7. The water absorption index for commercially-available product 1 and 2 were found to be 220.7 and 225.9, respectively.

TABLE 7
Comparison of Water Absorption
(Water Absorption Index)

| Enzyme Inclusion | Degree of Wetting (%) | | |
|---|---|---|---|
| Level (%) | 50% (1:1) | 60% (1:1.5) | 75% (1:3) |
| 0.0010 | 109.2 | 159.6 | 118.6 |
| 0.0030 | 182.9 | 212.5 | 168.1 |

### TVP as an Ingredient in a Vegan Meatball

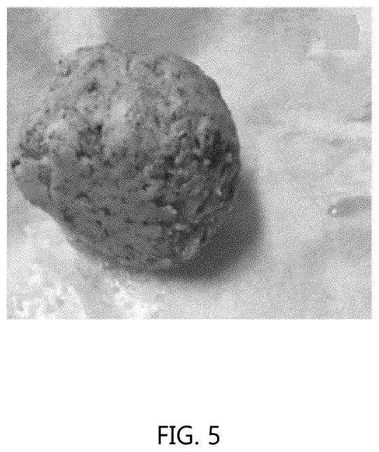

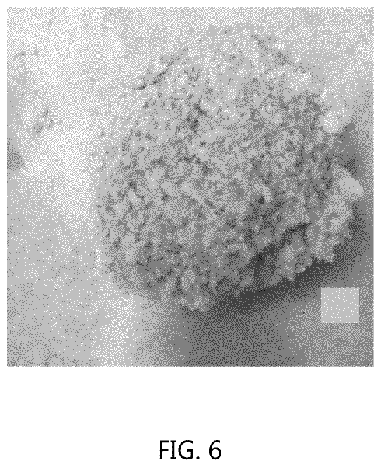

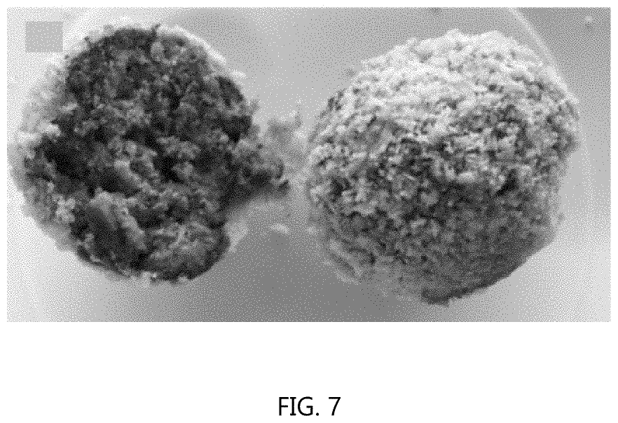

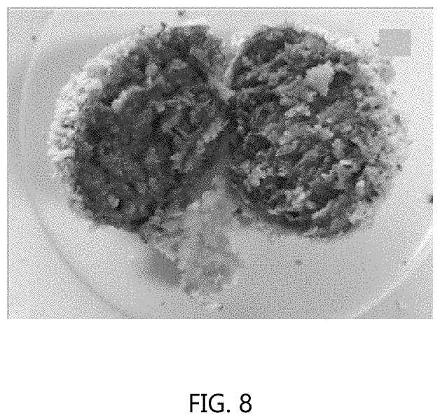

General ingredients for the vegan meatball are listed in Table 8. Textured vegetable protein was measured and added to boiling water and cooked for 10 minutes. (In an alternative method, boiling water was added to the textured vegetable protein and allowed to sit for 15 minutes on the table top.) Pea protein (Glanbia Nutritionals, Inc., Monroe, WI) was measured into a bowl, 10% TG pea was added and mixed thoroughly, the gum system, hydrogenated palm kernel oil and the seasoning blend was added to the mixture, and all were mixed. The textured pea protein was added to the dry blends and thoroughly mixed together. The oil and the water were subsequently added and mixed. The batter was molded into a meat ball and allowed to be sit on the table top for 30 minutes. A coating system was developed by using a 1% Flax in solution. FIGS. 5 and 7, respectively, show the freshly-made meatball prior to cooking and the cooked meatball.

TABLE 8
Ingredients for Vegan Meatball Using TG-TPP

| Ingredient | Formulation using different binders | | |
|---|---|---|---|
| Textured Pea Protein | 50 | 60 | 60 |
| HarvestPro pea 85 | 10.29 | 6 | 6 |
| 10% TG pea | 4 | — | — |
| Glanbia gum system | 1.6 | — | — |
| Flax | — | 0.5 | 0.5 |
| Chia | — | 0.5 | 0.5 |
| Ticaloid ® BIND I-96 Powder | — | — | 1 |
| Canola/coconut oil blend | 8 | 10 | 10 |
| Hydrogenated palm kernel oil | 8 | 8 | 8 |
| Seasoning blend | 4 | 4 | 4 |
| Water | 18 to 40 | 5-10 | 5-10 |

The 10% TG pea ingredient is an admixture of transglutaminase and pea protein at the ratio of 10 to 100, by weight. The gum system is an admixture of flax and pea protein at the ratio 40 to 60, by weight. The canola/coconut oil blend is an admixture of canola oil and coconut oil at the ratio of 60 to 40, by weight. The seasoning blend is a mixture of sundried tomatoes, paprika, nutritional yeast, garlic, salt, oregano, and flavor.

Table 9 shows the texture analysis for the meat ball made using textured pea as compared to a commercially-available beef-based meatball.

TABLE 9
Texture Analysis for Textured Pea-Based vs
Beef-Based (Commercial) Meatball (10% TG Binder)

| | Textured Pea- | |
|---|---|---|
| Type of Meatball | Based | Beef-based |
| Initial Slope | 65.4 | 120.8 |
| (g/sec) | | |
| Total Slope (g/sec) | 76.7 | 99.9 |
| Hardness (g) | 3562.5 | 5680.0 |
| Toughness/Chew | 96009.0 | 193923.7 |
| (g · sec) | | |
| Tackiness | −25.2 | −23.2 |
| Stickiness (g · sec) | −30.2 | −59.8 |

Use of TG-TPP to make Vegan “Meat” Patties

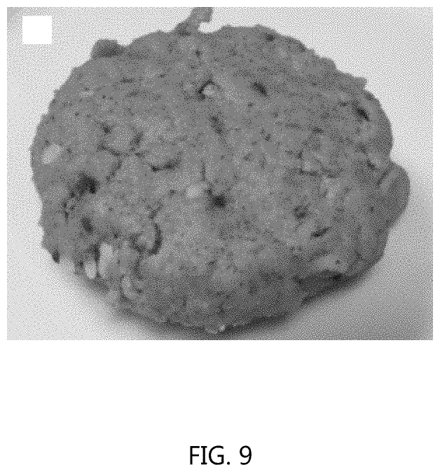

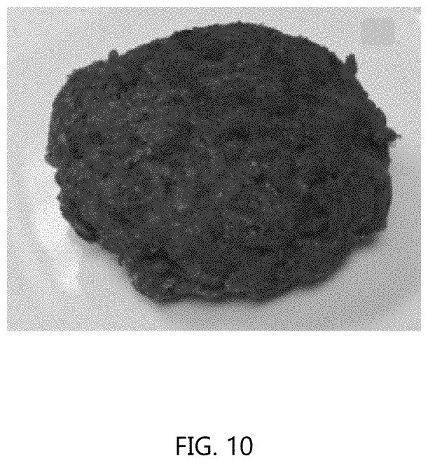

The ingredients for vegan meat patties are listed in Table 10. Textured vegetable protein was measured and added to boiling water and cooked for 10 minutes. (In an alternate process, boiling water was added to the TG-TPP and allowed to sit for 15 minutes on the table top). Pea protein was measured into a bowl, 10% TG pea was added and mixed thoroughly, the gum system, hydrogenated palm kernel oil and the seasoning blend was added to the mixture and mixed. The textured vegetable protein was added to the dry blends and thoroughly mixed together. The oil and the water were subsequently added and mixed. The batter was molded into meat balls and allowed to rest on a table top for 30 minutes. FIGS. 9 and 10 show freshly made veggie patties before and after cooking.

TABLE 10
Ingredients for Vegan Meat Patties

| | Formulation using | | |
|---|---|---|---|
| | different binders | | |
| Textured vegetable protein | 65.8 | 73 | 73 |
| Pea protein | 6.8 | 4.9 | 4.9 |
| 10% TG pea | 2.6 | — | — |
| Ticaloid ® BIND I-96 Powder | | 1 | — |
| Flax | | 0.5 | 0.5 |
| Chia | | 0.5 | 0.5 |
| Gum system (Glanbia) | 1.1 | — | — |
| Canola/coconut oil blend | 5.3 | 10 | 10 |
| Hydrogenated palm kernel oil | 2.6 | 6 | 6 |
| Seasoning blend | 2.6 | 4 | 4 |
| Water | 13.2 | 1-3 | 1-3 |

The seasoning blend is a mixture of liquid smoke, paprika, nutritional yeast, garlic, salt, oregano, and flavor.

### Use of TG-TPP in Vegan Sausage

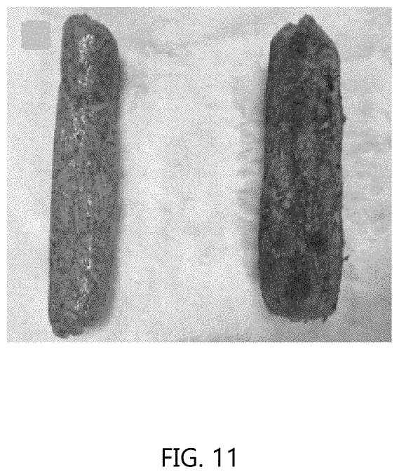

The ingredients for vegan sausage are listed in Table 11. Textured vegetable protein was measured and added to boiling water and cooked for 10 minutes. (Or boiling water was added to the textured vegetable protein and allowed to sit for 15 minutes on the table top). HarvestPro pea 85° (Glanbia Nutritionals, Monroe, WI) was measured into a bowl, and 10% TG pea was added and mixed thoroughly. The gum system, hydrogenated palm kernel oil, and the seasoning blend were added to the mixture and further mixed. The textured vegetable protein was added to the dry blends and thoroughly mixed together. The oil and the water were subsequently added and mixed. The batter was molded into meat ball and allowed to rest on the table top for 30 minutes. FIG. 11 is a photo of the freshly-cooked sausage.

TABLE 11
Ingredients for Vegan Sausage

| Ingredients | Amount (g) |
|---|---|
| Textured pea protein (TG-TPP) | 46.1 |
| HarvestPro pea 85® | 9.9 |
| TG Blend | 5.3 |
| Gum system (Glanbia) | 1.3 |
| Canola/coconut oil blend | 5.3 |
| Seasoning blend | 2.6 |
| Water | 29.6 |

The seasoning blend was a mixture of liquid smoke, paprika, nutritional yeast, garlic, salt, oregano, and flavor.

### Use of TG-TPP in Vegan Chicken Nugget

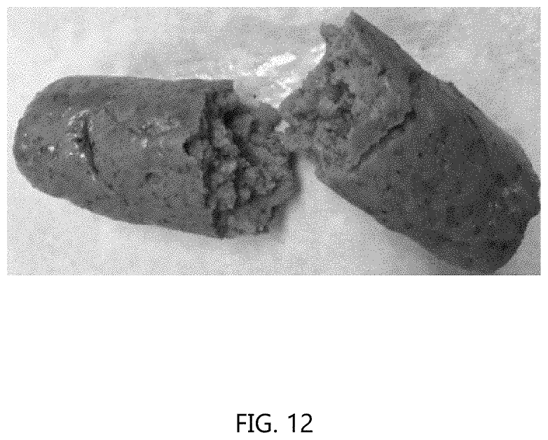

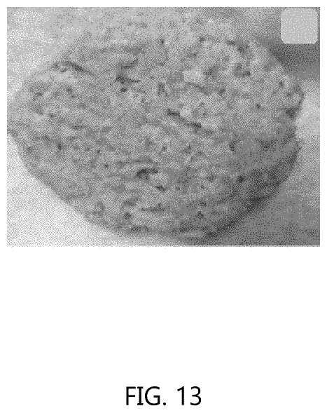

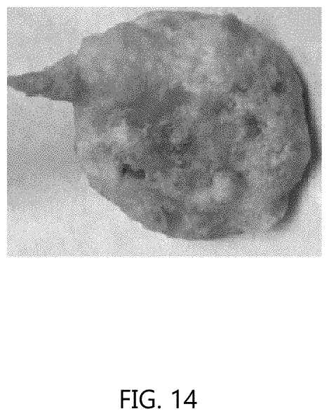

Ingredients for making a vegan chicken nugget using TG-TPP are listed in Table 12. Textured vegetable protein was measured and added to boiling water and cooked for 10 minutes. (Or boiling water was added to the textured vegetable protein and allowed to sit for 15 minutes on the table top). The textured vegetable protein was added and mixed with the other ingredients in a blender. About 21 g of the blend was measured, formed into a disc, and placed in the freezer for 10 minutes. Afterward, the nugget was dipped into a flour dredge and tempura batter in preparation for frying (for 2 minutes). FIG. 12 is a photo of a freshly-made nugget, and the FIG. 13 the nugget after it was dipped in tempura batter and fried.

TABLE 12
Ingredients for TG-TPP Chicken Nugget

| Ingredients | Amount (g) |
|---|---|
| Textured vegetable protein | 87.5 |
| Canola/coconut oil blend | 7.3 |
| Corn flour | 1.8 |
| Flax | 0.9 |
| Seasoning blend | 2.4 |

The seasoning blend was a mixture of garlic, onion, salt, pepper, and flavor.

### Use of TG-TPP in Vegan Crumbles

Ingredients for making a vegan crumbles product using TG-TPP are listed in Table 13. Textured vegetable protein was measured and added to boiling water and cooked for 10 minutes. (Or boiling water was added to the textured vegetable protein and allowed to sit for 15 minutes on the table top). The seasoning blend was added to the desired amount of liquid mix (water, liquid smoke and soy sauce). The admixture was boiled for 2 minutes before adding the textured vegetable protein. The admixture was allowed to cook until the liquid system was completely absorbed or evaporated.

TABLE 13
Ingredients for TG-TPP Crumbles

| Ingredients | Amount (g) |
|---|---|
| Textured vegetable protein | 77 |
| Liquid system | 19 |
| Seasoning blend | 4 |

The seasoning blend comprised chili powder, garlic powder, onion powder, red pepper flakes, oregano, paprika, cumin, salt and black pepper.

What is claimed is:

1. A method for producing a textured plant protein product, the method comprising the steps of
(a) admixing water, transglutaminase, and plant protein to produce a water/transglutaminase plant protein admixture;
(b) holding the admixture for a period of time sufficient to produce a gelatinized protein cake;
(c) grinding the gelatinized protein cake to produce a ground protein product; and
(d) drying the ground protein product at a drying temperature of from about 60 to about 300 degrees Celsius, to produce a textured plant protein product.

2. The method of claim 1 wherein the plant protein is at least one pea protein.

3. The method of claim 1 wherein step (b) comprises holding the admixture for a period of from 0.5 minutes to about 60 minutes.

4. The method of claim 1 wherein the ratio of water to pea protein in the admixture comprises from about 0.5:1 to about 5:1.

5. The method of claim 1 wherein the transglutaminase is added at from about 0.0001 percent to about 10 percent of the admixture, by weight.

6. The method of claim 1 wherein the transglutaminase is a microbial transglutaminase.

7. The method of claim 1 wherein step (c) is performed using a meat grinder.

8. The method of claim 1 wherein the transglutaminase is present at from about 0.01% to about 10%, by weight.

9. The method of claim 1 wherein the plant protein is selected from the group consisting of protein from red lentils, green lentils, yellow lentils, brown lentils, chickpeas, garden peas, black-eyed peas, runner beans, fava beans, kidney beans, and combinations thereof.

10. A formed meat substitute product comprising:
(a) at least one textured protein product made by a method comprising the steps of admixing water, transglutaminase, and plant protein to produce a water/transglutaminase/plant protein admixture; holding the admixture for a period of time sufficient to produce a gelatinized protein cake; grinding the gelatinized protein cake to produce a ground protein product; and drying the ground protein product at a drying temperature of from about 60 to about 300 degrees Celsius, to produce a textured plant protein product;
(b) at least one plant protein; and
(c) a binding agent selected from the group consisting of transglutaminase, at least one hydrocolloid, and combinations thereof.

11. The formed meat substitute product of claim 10, wherein the at least one plant protein comprises at least one pea protein.

12. The formed meat substitute product of claim 10 wherein the hydrocolloid is selected from the group consisting of chia mucilage, flax mucilage, carrageenan, gum arabic, locust bean methylcellulose, guar gum, gellan gum, tara gum, konjac gum, modified gum acacia, xanthan gum, pectin, and combinations thereof.
